(19) United States
(12) Patent Application Publication
(10) Pub. No.: US 2017/0201434 A1
(43) Pub. Date: Jul. 13, 2017

(54) RESOURCE USAGE DATA COLLECTION WITHIN A DISTRIBUTED PROCESSING FRAMEWORK

(71) Applicant: Hewlett Packard Enterprise Development LP, Houston, TX (US)

(72) Inventors: Qianhui Liang, Singapore (SG); Bryan Stiekes, Brownstown Township, MI (US); Ludmila Cherkasova, Sunnyvale, CA (US)

(21) Appl. No.: 15/314,826

(22) PCT Filed: May 30, 2014
(86) PCT No.: PCT/US2014/040296

§ 371 Date: Nov. 29, 2016

(51) Int. Cl. H04L 12/26; H04L 29/08

(52) U.S. Cl. CPC H04L 43/08; H04L 43/16; H04L 67/10

(57) ABSTRACT

Examples disclosed herein relate to updating a controller of a computational resource system that provides a computing capability to a distributed processing framework. An analysis engine of the distributed processing framework may collect resource usage data characterizing consumption of a compute resource of the computational resource system in providing the computing capability to a framework nodes of the distributed processing framework. Using the resource usage data, the analysis engine may update the controller of the computational resource system with actionable data affecting the computing capability.

### BACKGROUND

Computer networks and systems have become indispensable tools for modem business. Today, terabytes of information on virtually every subject imaginable are stored and accessed across networks. To make this information more usable, many businesses deploy computer systems that process or mine data to derive new data or insights from that data. This process of data mining or data processing may be generally referred to as analytics. Many systems may utilize a distributed processing framework to perform such analytics. MapReduce, as may be implemented by Hadoop, is an example of a distributed processing framework.

### BRIEF DESCRIPTION OF DRAWINGS

Examples of embodiments are described in detail in the following description with reference to examples shown in the following figures:

FIG. 1 is a system diagram illustrating a system for hosting a distributed processing framework, according to an example;

FIG. 2 is a layered view of the system of FIG. 1 illustrating modules of the distributed processing system and the computational resource system, according to an example;

FIG. 3 is a flowchart illustrating a method for updating a computational resource system based on resource usage data collected from a distributed processing framework, according to an example;

FIG. 4 is a diagram illustrating a method for sending updates to a controller based on a quality threshold of a prediction, according to an example

FIGS. 5A-B are system diagrams illustrating a system that updates a computational resource system based on resource usage data collected by a distributed processing framework, according to an example;

FIG. 6 is a diagram illustrating an operation of a MapReduce system, according to an example; and

FIG. 7 is a block diagram of a computing device capable of updating a controller of a computational resource system based on monitored resource usage data, according to one example.

### DETAILED DESCRIPTION

For simplicity and illustrative purposes, the principles discussed in this disclosure are described by referring mainly to examples thereof. It is to be understood that the examples may be practiced without limitation to all various implementations. Also, examples may be used together in various combinations.

This disclosure describes, among other things, examples of systems, methods, and storage devices for updating a computational resource system based on resource usage data collected by a distributed processing framework. Examples disclosed herein relate to updating a controller of a computational resource system that provides a computing capability to a distributed processing framework. An analysis engine of the distributed processing framework may collect resource usage data characterizing consumption of a compute resource of the computational resource system in providing the computing capability to a framework nodes of the distributed processing framework. Using the resource usage data, the analysis engine may update the controller of the computational resource system with actionable data affecting the computing capability.

As further illustration, a distributed processing system may include a cluster of framework nodes (referred herein as a “framework node cluster”) communicatively coupled to a computational resource system, such as a software defined network, that provides a computing capability to the distributed processing framework. As described below, a framework node, as used herein, may refer to an instance of a node, module, or application container of a distributed processing framework that schedules, manages, coordinates, and/or executes tasks of a job submitted to a distributed processing system.

The distributed processing framework may execute a job by partitioning the job into a plurality of tasks and then distributing the plurality of tasks throughout the framework node cluster. In processing the plurality of tasks, the framework node cluster may consume compute resources provided by the computational resource system, such as network bandwidth, processor time, memory, storage, virtual machines, and the like.

In an example system, one of the framework nodes of the framework node cluster may also include a monitor daemon that monitors resource usage data characterizing a compute resource consumed by a framework node in the computational resource system providing the computing capability to the framework node cluster. To illustrate, in some cases, the monitor daemon may monitor network traffic initiated by one framework node in the framework node cluster in exchanging values to other framework nodes in the framework node cluster.

Another framework node from the framework node cluster may also further include an analysis engine that is configured to collect the resource usage data from the monitor daemon. The analysis engine may also update a controller of the computational resource system with actionable data usable by the controller to schedule resources for providing the computing capability at a future time. The actionable data may be derived from the resource usage data. As described above, in some cases, the computational resource system may be a software defined network. Accordingly, an example analysis engine may then generate a prediction of future network bandwidth usage. The analysis engine may update the controller of the software defined network with this prediction so that the controller can adjust the data plane of the network to better handle future traffic from the distributed processing framework communicated through the network.

Updating a controller of a computational resource system with data derived from resource usage data collected by a distributed processing framework may find many practical applications. For example, a distributed processing framework that collects resource usage data may use the collected resource usage data to provide the computational resource system with actionable data that allows the computational resource system to better schedule resource usage. To illustrate, consider an example distributed processing system that runs jobs using a MapReduce framework. In the MapReduce framework, computation can execute according to phases that include: a map phase, a shuffle phase, and a reduce phase. The map phase involves map tasks processing an input data set, possibly in one domain, and producing a list of key-value pairs, possibly in another domain. The reduce phase involves reduce tasks processing the output of the map tasks (e.g., the list of key-value pairs) to generate a collection of values. Generating the collection of values may involve the reduce tasks merging or aggregating all the key-value pairs associated with the same key. In between the map phase and the reduce phase, the MapReduce framework may execute a shuffle phase. In the shuffle phase, a shuffle task sorts and redirects the key-value pairs generated by the map tasks of the map phase to the appropriate reduce task of the reduce phase. Because the tasks of the MapReduce framework may be distributed over a cluster of framework nodes executing on different physical devices (or virtual devices executed on a physical host device), redirecting the key-values pairs from a map task to a reduce task may involve inter-device communication (referred to herein as framework messages), such as communication over a network. This may be the case where data is exchanged between tasks executing on different racks or, in some highly distributed set-ups, in different datacenters or regions. This may also be the case where iterative executions of map and reduce tasks require communication of data from reduce tasks to map tasks.

However, an example distributed processing framework that relies on a software defined network to exchange data between framework nodes located on different racks can provide the software defined network with data derived from the resource usage data so that the software defined network can adjust routing and links to avoid hot-spot links, distribute network traffic to communication links to better fulfill service level agreements, and/or reserve networking capabilities. Examples can provide the software defined network with this type of actionable data to, in some cases, avoid situations where the distributed processing system unknowingly assigns tasks to framework nodes that are located on racks connected via paths or links in the software defined network that are over-congested by communications initiated by other tenants using the software defined network.

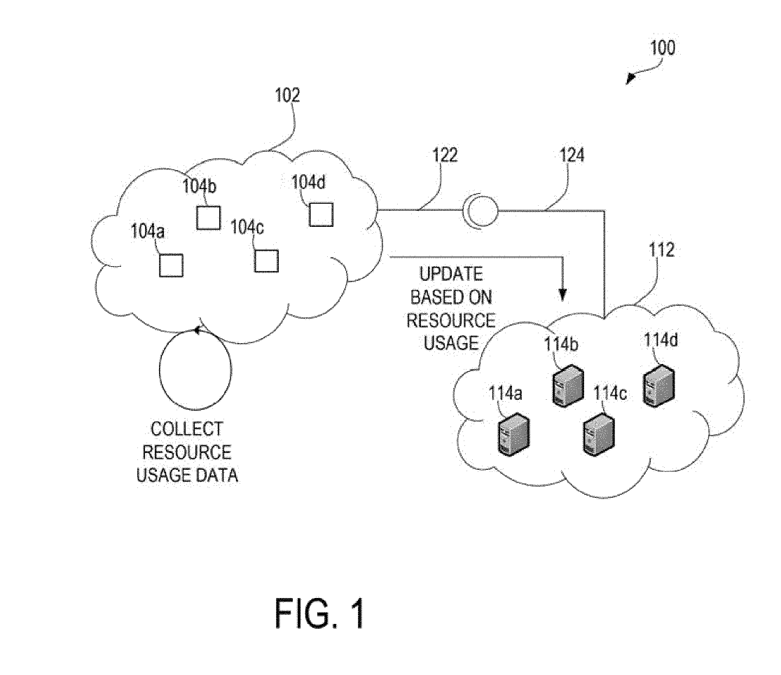

Referring now to the drawings, FIG. 1 is a system diagram illustrating a system 100 for hosting a distributed processing framework, according to an example. FIG. 1 shows that the system 100 includes a distributed processing system 102 communicatively coupled to a computational resource system 112. The distributed processing system 102 may include framework nodes 104a-d. Each of the framework nodes 104a-d may be a node, module, or application container of a distributed processing framework that schedules, manages, coordinates, and/or executes tasks of a job submitted to the distributed processing system 102. The framework nodes 104a-d may be computer-implemented modules executed by physical computer systems, such as a computer server or a rack of servers. In other cases, the framework nodes 104a-d may be executed by virtual computer systems, such as a virtual machine, that are, in turn, executing on a host device (e.g., or host devices).

With continued reference to FIG. 1, the computational resource system 112 may be a computer system that provides a computing capability (e.g., network communication, processing time, memory, storage, and the like) to the distributed processing system 102. In some cases, to provide a computing capability, the computational resource system 112 pools together compute resources to serve multiple consumers using a multi-tenant model, which different physical and virtual resources are dynamically assigned and reassigned according to demand, and, in some cases, scaled out or released to provide elastic provisioning of computing capabilities. In some cases, a computing capability provided by the computational resource system 112 is limited or otherwise affected by a compute resource of the computational resource system 112. Examples of compute resources include storage, processing, memory, network bandwidth, and virtual machines. To illustrate, in some cases the computational resource system 112 may be a software defined network that provides a computing capability of communicating data between the framework nodes 104a-d, such as through a data path, link, or the like provided by the software defined network. The computational resource system 112 includes resource devices 114a-d, each of which executes or otherwise participates in providing the computing capability offered by the computational resource system 112.

Operationally, the computational resource system 112 provides a computing capability used by the distributed processing system 102 when the distributed processing system 102 executes a job. This is illustrated in FIG. 1 by the ball 124 and socket 122, which merely intends to signify that the execution of job and constituent tasks may consume compute resources of the distributed processing system 112. For example, the computational resource system 112 may provide network communication, processing time, memory, storage, and other suitable computing capabilities that are used to by the distributed processing system 102.

FIG. 1 illustrates that the distributed processing system 102 may monitor resource usage occurring within the computational resource system 112 during the execution of a distributed processing framework. Further, FIG. 1 illustrates that the distributed processing system 102 may update the computational resource system 112 based on the resource usage data monitored by the distributed processing system 102. As is explained in greater detail below, updating the computational resource system 112 may cause the computational resource system 112 to better manage the resource devices 114a-d.

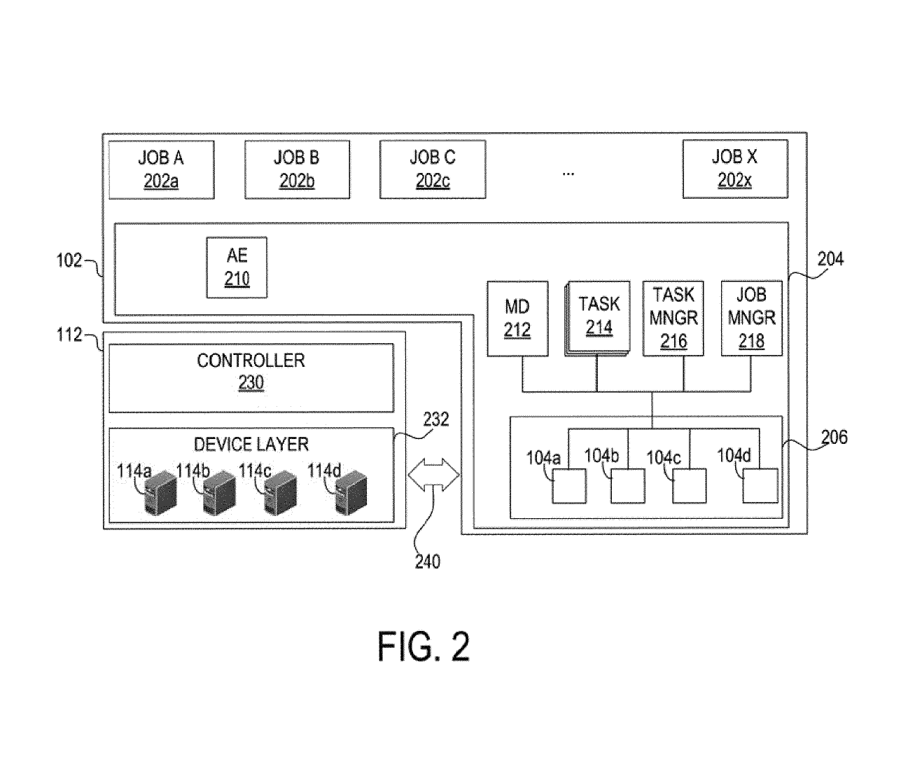

FIG. 2 is a layered view of the system 100 of FIG. 1 illustrating modules of the distributed processing system 102 and the computational resource system 112, according to an example. In addition to illustrating modules of the distributed processing system 102 and the computational resource system 112, FIG. 2 also highlights an example where the distributed processing system 102 and the computational resource system 112 are separate and distinct systems where modules of the distributed processing system 102 (e.g., the analysis engine 210) is at the application layer of the computational resource system 112.

The distributed processing system 102 may include jobs 202a-x and a distributed processing framework 204. A job may represent a work item that is to be run or otherwise executed by the distributed processing system 102. A job, such as one of the jobs 202a-x, may include properties that specify various aspects of the job, including job binaries, pointers to the data to be processed, command lines to launch tasks for performing the job, a reoccurrence schedule, a priority, or constraints. For example, a job may include properties that specify that the job is to be launched every day at 5 PM. As discussed below, during execution, a job may be partitioned into several tasks (e.g., tasks 214) that work together to perform a distributed computation. The jobs 202a-x may be submitted by a user of the distributed processing system 102.

The distributed processing framework 204 may be a distributed framework that runs or otherwise executes the jobs 202a-x over a framework node cluster 206. As FIG. 2 shows, the distributed processing framework 204 may include an analysis engine 210, a monitor daemon 212, tasks 214, a task manager 216, and a job manager 218 that execute on the framework node cluster 206. The analysis engine 210 may be a computer-implemented module configured to, among other things, collects resource usage data from the framework nodes cluster 206, sends actionable data to the computational resource system 112, and receives resource usage data from the computational resource system 112.

The monitor daemon 212 may be a computer-implemented module configured to track data relating to the compute resources consumed by the computational resource system 112 in providing the computing capability to the distributed processing framework 204.

The tasks 214 may be computer-implemented modules configured to execute portions of the jobs 202a-x. To illustrate, in the context of a MapReduce framework, the tasks 214 may represent map tasks and reduce tasks. In some cases, the tasks 214 may be phased-based, such that the output of one of the tasks (e.g., a map task) is to be input of another task (e.g., a reduce task). Thus, in some cases, execution of one of the tasks 214 may depend on the execution of another task.

The task manager 216 may be a computer-implemented module configured to manage the tasks 214 executing on the framework nodes 104a-d. In some cases, the task manager 216 may be a framework node in the framework node cluster that accepts tasks (e.g., map, reduce and/or shuffle) from the job manager 218. The task manager 216 may be configured with a set of slots that indicate the number of tasks that it can accept. When the task manager 216 is assigned a task by the job manager 218, the task manager 216 spawns a process (e.g., a java virtual machine) to do the task-specific processing. The task manager 216 may then monitor these spawned processes, capturing the output and exit codes. When the process finishes, successfully or not, the task manager 216 notifies the job manager 218.

The job manager 218 is a computer-implemented module configured to push work out to an available task manager in the framework node duster 206. In some cases, the job manager 218 may operate to keep the work as dose to the data as possible. With a rack-aware file system, the job manager 218 includes data specifying which framework node contains data, and which other framework nodes are nearby. If the work cannot be hosted on the actual framework node where the data resides, priority is given to the nearby framework nodes, which may reside in the same rack.

The framework node cluster 206 may include the framework nodes 104a-d. As described above with reference to FIG. 1, each of the framework nodes 104a-d may be a framework node of a distributed processing framework that schedules, manages, coordinates, and/or executes tasks of a job submitted to the distributed processing system 102. The framework node clusters may be implemented on a physical device (e.g., a hardware server) or virtual device (e.g., a virtual machine) operating on a physical device (e.g., a host).

In operation, instances of the modules of the distributed processing framework 204 may be distributed across the framework nodes 104a-d. For example, the framework node 104c may operate as a master framework node and framework nodes 104a,b,d may operate as worker (or, alternatively, slave) framework nodes to the framework node 104c. In such a configuration, the framework node 104c may execute instances of the analysis engine 210, the monitor daemon 212, the job manager 218, the task manager 216, and tasks 214. Further, the framework nodes 104a,b,d, configured as worker framework nodes, may each execute instances of the monitor daemon 212, tasks 214, and the task manager 216.

With respect to the computational resource system 112, FIG. 2 shows that the computational resource system 112 includes a controller 230 and a device layer 232. The controller 230 may be a computer-implemented module that manages the operation or configuration of the device layer 232. In some cases, the computational resource system 112 may be a software defined network and, as such, the controller 230 may manage the control plane of the software defined network. In such a case, the controller 230 may configure the device layer 232 to define network paths or links between the resource devices 114a-d that are usable for communicating data between the framework nodes 104a-d. In this case, network bandwidth of network paths or links provided by the device layer may be a compute resource of the computational resource system 112 that may be consumed during the operation of the distributed processing system 102. In other cases, the controller 230 may be a cloud controller that manages the various resources of a cloud system, such as managing a database service, a message queue service, a scheduling service, images, virtual machine provisioning, and the like. In these cases, compute resources provided by the device layer (e.g., processing time, storage, and the like) are compute resources of the computational resource system 112 that may be consumed during the operation of the distributed processing system 102.

The device layer 232 includes the resource devices 114a-114d. As described above, resource devices 114a-d may be computer systems that provide a computing capability used by the distributed framework system 102 in executing the jobs 202a-x. For example, the resource devices 114a-114d may be networking devices used to exchange data between the framework nodes 104a-d. As another example, the resource devices 114a-114d may be the underlying hardware that hosts virtual machines. In this virtual machine example, the framework nodes 104a-d may then be virtual machines executing on the resource devices 114a-d.

FIG. 2 shows that the framework nodes 104a-d, in executing the distributed processing framework, may consume compute resources from the resource devices 114a-d. This is shown by arrow 240. The consumption may be measured based on usage of memory or storage, communication bandwidth, processor time, communication requests, web server thread, virtual machines, and the like.

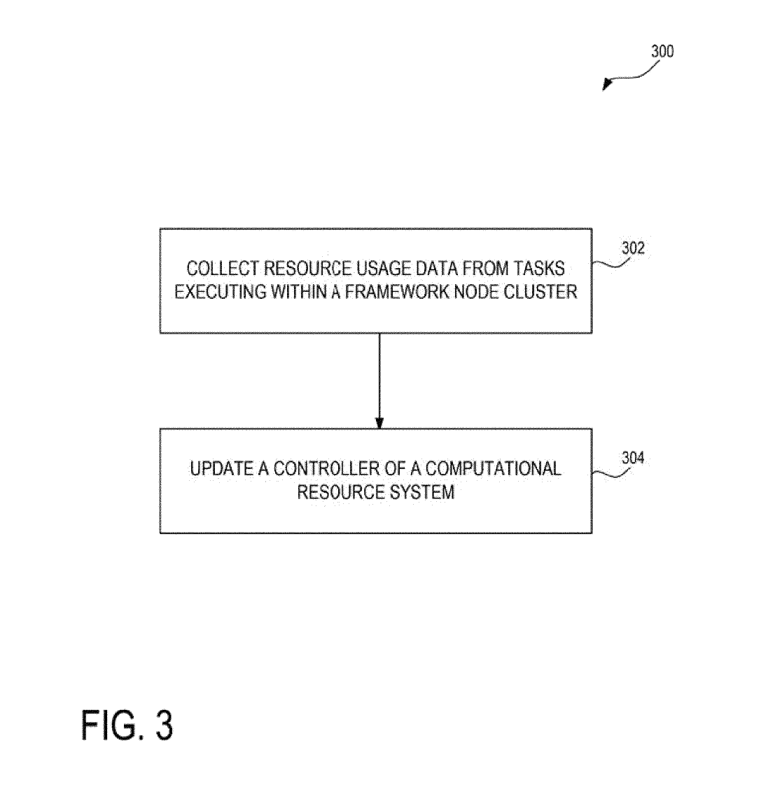

Operations of updating a computational resource system are now described in greater detail. FIG. 3 is a flowchart illustrating a method 300 for updating a computational resource system based on resource usage data collected from a distributed processing framework, according to an example. The operations of the method 300 may be executed by computer systems. For clarity of description, and not as a limitation, the method 300 is described with reference to the components and modules of FIGS. 1 and 2. For example, the method 300 may be performed by modules of a distributed processing framework. As discussed above, a distributed processing framework may include a framework node cluster that executes tasks of a job. In executing the tasks of a job, a computational resource system 104 may provide a computing capability (e.g., e.g., network communication or provisioning of processing time, memory, storage, and the like) to the framework node cluster for executing the tasks.

At operation 302, the analysis engine 210 may collect resource usage data characterizing consumption of a compute resource of the computational resource system in providing the computing capability to the at least one of the plurality of framework nodes. Merely as an example and not a limitation, an example of a compute resource consumed by the set of devices is network bandwidth. Other examples of compute resources that may be consumed by the set of devices includes memory or storage, communication bandwidth, processor time, communication requests received by a message queue (e.g., where the computing capability is a web server or load balancer), web server thread, virtual machines, and the like. In some cases, the analysis engine 210 may collect the resource usage data from the monitor daemon 212 (or monitor daemons) executing within the framework node cluster of the distributed processing framework.

At operation 304, the analysis engine 210 may then use the resource usage data to update the controller 230 of the computational resource system 112 with actionable data affecting the computing capability. Actionable data may include, for example, a prediction of future resource usage that is usable to schedule, configuration, management of compute resources of the computational resource system 114a-d. As is described in greater detail below, the analysis engine 210 may generate a prediction of future resource usage based on performing calculations on the resource usage data collect at operation 302.

Examples of actionable data passed from the analysis engine 210 to the controller 230 are now discussed. The controller 230 of the computational resource system 112 can take in requests from the analysis engine 210 and apply the appropriate policies on their behalf. An example of policies applied by the controller 230 are routing decisions. For example, the controller 230 can reroute the communication between framework nodes using all-pair shortest path. The all-pair shortest path is applied on the matrix of bandwidth availability Bₜ at time t. B_{i,j,t} is the available bandwidth on the link from the ith rack to the jth rack. B_{i,j,t} can be calculated as the difference between the link capacity and the predicted traffic usage (e.g., the actionable data) on the link.

The method 300 may be used by a distributed processing framework to communicate compute resource needs to a computational resource system that handles infrastructure needs of the distributed processing framework. Such may be the case when the distributed processing framework communicates a pattern of resource usage to the computational resource system. Based on the pattern of resource usage, the computational resource system can then adjust the configuration of the resource devices to better accommodate or service the distributed processing framework. Such may be useful where, for example, the computational resource system is a multitenant system that provides a computing capability to multiple users, programs, and/or systems. Thus, rather than a distributed processing framework scheduling resource usage for the computational resource system, the computational resource system may use the actionable data provided by the distributed processing framework to schedule resource usage among the multiple tenant.

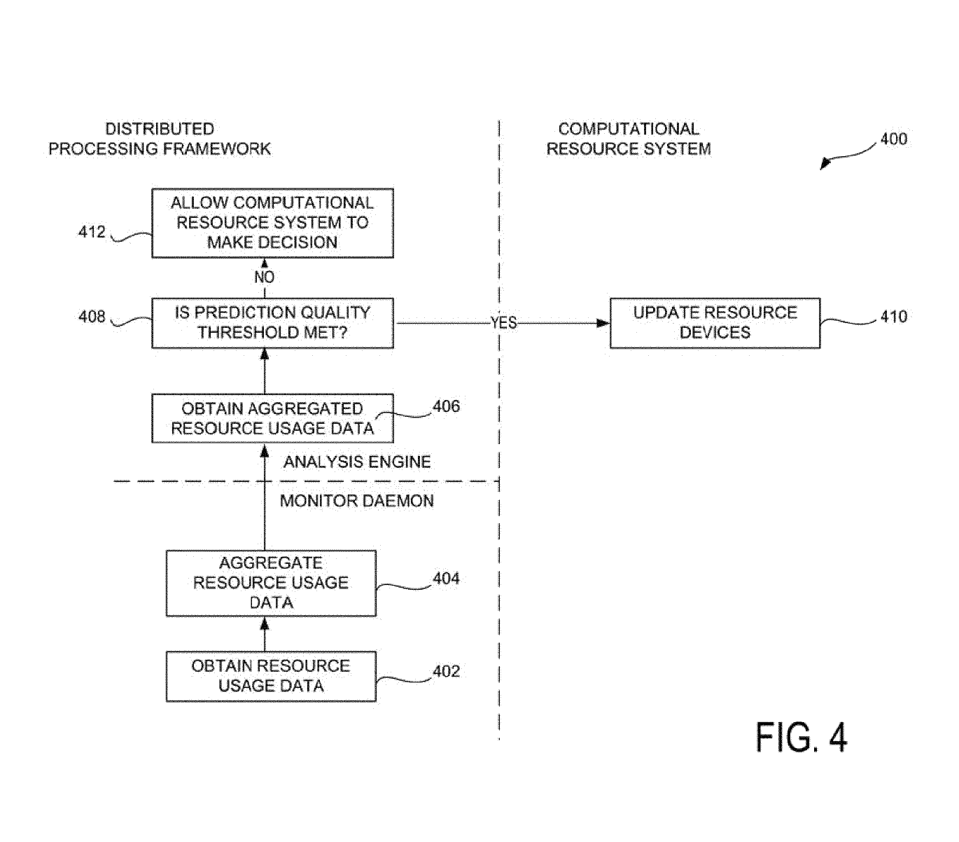

In some cases, an analysis engine 210 may update the controller 230 of a computational resource system 112 based on a measurement of the quality of the prediction. FIG. 4 is a diagram illustrating a method 400 for sending updates to the controller 230 based on a quality threshold of a prediction, according to an example.

In FIG. 4, at operation 402, the monitor daemon 212 (or monitor daemons) executing on framework nodes obtains resource usage data. At operation 404, the monitor daemon 212 may also aggregate the resource usage data. The aggregated resource usage data is then collected by the analysis engine 210 at operation 406 and, as described above, a prediction of future resource usage can be generated by the analysis engine 210. At operation 408, the analysis engine 210 then determines whether the prediction of future resource usage meets a prediction quality threshold by generating or calculating a prediction error associated with the prediction of future resource usage and then comparing the prediction quality threshold with the prediction error. If the prediction quality threshold has not been met, the analysis engine 210 may elect, as shown at operation 412, to allow the computational resource system 112 to manage resource usage within the computer resource system. Otherwise, if the prediction quality threshold has been met, the analysis engine 210 communicates actionable data to the controller 230, and the controller 230 can update, at operation 410, the resource devices 114a-d at the device layer 232 using the actionable data.

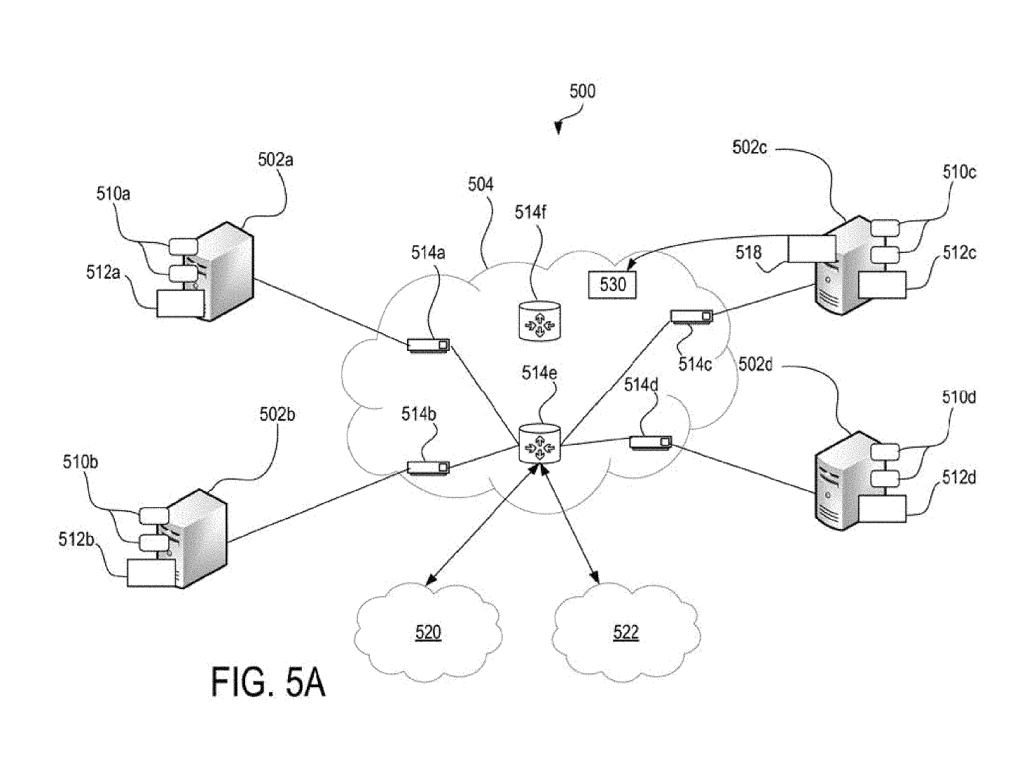

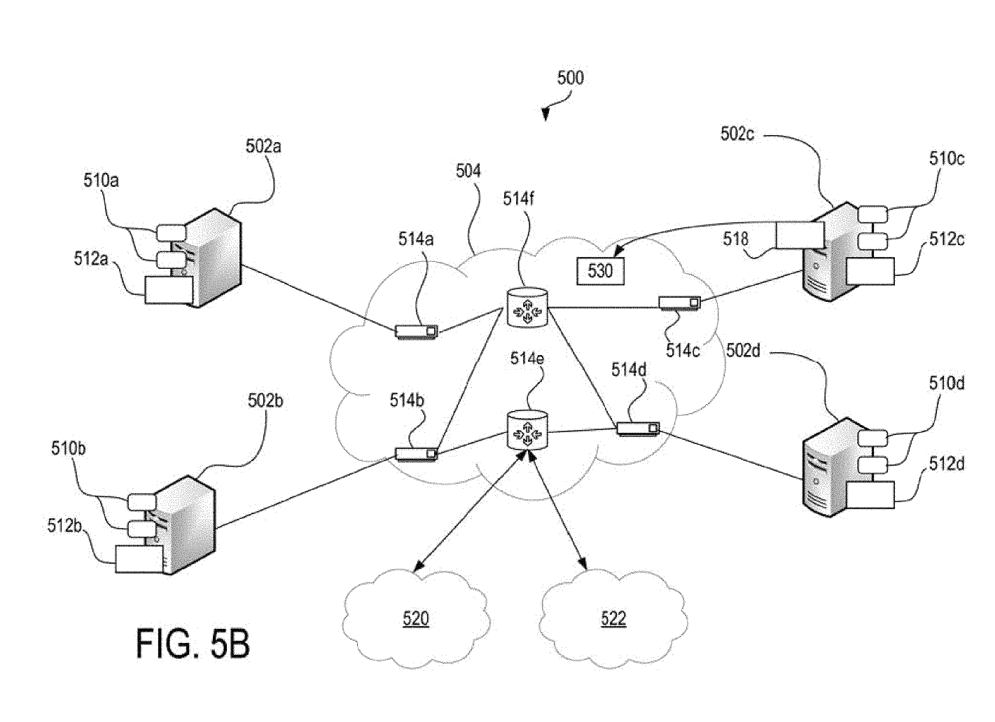

An example of a system that updates a software defined network is now discussed. FIGS. 5A-B are system diagrams illustrating a system 500 that collects resource usage data from framework nodes 502a-d and updates a computational resource system 504 using the resource usage data, according to an example. The framework nodes 502a-d may be framework nodes of a distributed processing framework. For example, the framework nodes 502a-d may each execute tasks (e.g., tasks 510a-d) and monitor daemons 512a-d. Further, at least one of the framework nodes may include an analysis engine, such as the analysis engine 518.

The framework nodes 502a-d communicate to each other through the computational resource system 504. By way of example and not limitation, the computational resource system 504 is a software defined network that provides the infrastructure for the framework nodes to exchange data with each other. The computational resource system 504 includes networking devices 514a-f and a controller 530. The networking devices 514a-f may provide data connection for exchanging data between the framework nodes 502a-d of the distributed processing framework. Switches, routers, bridges, gateways, and other suitable networking devices are all examples of different types of networking devices that provide data connections in a data network. The controller 530 may be configured to provide a control plane that provides management of the network links and paths between the networking devices 514a-f.

Accordingly, in the example shown in FIG. 5A, the computational resource system 504 provides an infrastructural computing capability of exchanging data from one framework node to another. A type of compute resource that may be consumed in providing this type of infrastructural computing capability may be network bandwidth. Such is the case because the computational resource system 504 may be limited in the amount of data that a communication path between two framework nodes may send over a given period of time.

FIG. 5A illustrates, among other things, that the networking device 514e is used to route all messages exchanged by the distributed processing framework. That is, the network link or path used to communicate data from framework node 502a to any other framework node includes the networking device 514e. The same is true that the network links and paths used to communicate data to and from framework nodes 502b-d also include networking device 514e.

However, relying on the networking device 514e to communicate a disproportional amount of data through the computational resource system 504 may cause the networking device 514e to be a communication bottleneck in the computational resource system 504. For example, the data exchanged between the framework nodes 502a-d may exceed a bandwidth supported by the router 514e. This bottleneck issue may be exacerbated if the networking device 514e forms a data path for any other external systems, such as is the case in FIG. 5A as the networking device 514e routes data between systems 520 and 522.

In contrast to the networking device 514e, the networking device 514f may be an underutilized computational resource because the networking device 514f is not used to communicate (e.g., route) data among the framework nodes 502a-d.

The monitor daemons 512a-d may track resource usage data consumed by the tasks of the framework nodes 510a-d being consumed by operation of the distributed processing framework. For example, the monitor daemon 512a may track the amount of data being communicated from the framework node 502a to the other framework nodes 502b-d. The monitor daemon 512b may track the amount of data being communicated from the framework node 502b to the other framework nodes 502a,c-d. The monitor daemon 512c may track the amount of data being communicated from the framework node 502c to the other framework nodes 502a,b,d. The monitor daemon 512d may track the amount of data being communicated from the framework node 502d to the other framework nodes 502a-c.

The analysis engine 518 may then collect the resource usage data tracked by each of the monitor daemons 512a-d and provide actionable data to the controller 530 of the computational resource system 504. The controller 530 may then use the actionable data to update or otherwise coordinate the compute resources of the computational resource system 504 to better route data from one framework node to another. For example, the actionable data may include data representing, among other things, the amount of data being sent from a source framework node to a destination framework node. With this information, the controller 530 may, for example, determine that the data plane (e.g., network links or paths) of the computational resource system is better utilized using a different topology.

FIG. 5B is a diagram illustrating an example response by the controller 530 of the computational resource system to an update from the analysis engine 518. For example, the controller 530 may have updated the data plane of the networking devices 514a-f such that networking device 514f is now involved in the communication path or link used to exchange data sent from or destined to the framework node 502. For example, communication data sent from or to framework node now uses networking device 514f, rather than networking device 514e (as was the case for FIG. 5A).

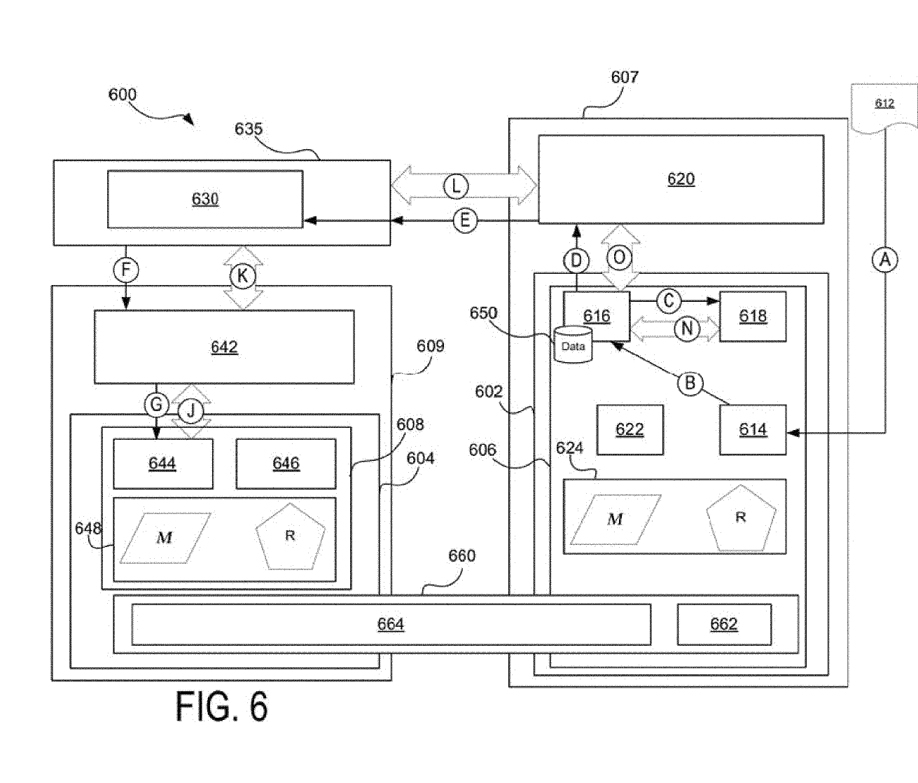

As discussed above, examples contemplated herein may be applied to a distributed processing framework such as a MapReduce system. FIG. 6 is a diagram illustrating an operation of a MapReduce system 600, according to an example. In FIG. 6, the MapReduce system 600 may be configured to track bandwidth usage of a software defined network 635. For clarity, the block arrows J, K, L, N, O represent data flow and line arrows A, B, C, D, E, F, G, represent control signals.

The MapReduce system 600 includes computer devices 602, 604 communicatively coupled to the software defined network 635 and a controller 630 of the software defined network 635. The computer devices 602, 604 may be computer devices at different or the same data centers. For example, the computer device 602 may be a server on a rack 609 and the computer device 604 may be a server on a rack 607. FIG. 6 illustrates that each of the computer devices 602, 604 may host a framework node (e.g., framework nodes 606, 608) of a distributed processing framework. As discussed above, a framework node may include instances of an analysis engine, a monitor daemon, a job manager, a task manager, and/or a set of tasks. With respect to the example shown in FIG. 6, the framework node 606 includes an analysis engine 616, monitor daemon 618, job scheduler 614, task manager 622, and tasks 624, while the framework node 608 includes a monitor daemon 644, job scheduler 646, and tasks 648. To clarify description of FIG. 6, framework node 606 may be referred to as a master framework node and the framework node 608 may be referred to as a worker framework node. In a Hadoop environment, the worker framework nodes may perform jobs or tasks of the MapReduce framework and the master framework node may perform administrative functions of the MapReduce framework such as to provide a point of interaction between an end-user and the cluster, manage job tasks, and regulate access to the file system. Although examples in this disclosure are discussed with respect to a Hadoop environment, one skilled in the art can readily apply the concepts to other environments.

In some cases, the distributed processing framework may include a distributed file system 660, such as the Hadoop Distributed File System module that is released with Hadoop or Google's Google File System. The distributed file system 660 may store data (e.g., files) across multiple computer devices. The distributed file system 660 may include a name framework node 662 that acts as a master server that manages the file system namespace and regulates access to files by clients. Additionally, there is a data split 664 of the data stored by the distributed file system 660. In some cases, the data split 664 is managed by data framework nodes, which act as servers that manage data input/output operations. To compare the roles of the name framework node 662 and data framework nodes, the name framework node 662 executes file system namespace operations like opening, closing, and renaming files and directories. The name framework node 662 may also determine the mapping of blocks to data split 664. A data framework node for the data spit 664 may be responsible for serving read and write requests from clients of the distributed file system 660.

Separate from executing modules of a distributed processing framework (e.g., the worker framework node 608 and the master framework node 606), the computer devices 602, 604 may each include modules that are communicatively coupled to the software defined network 635 to communicate data between the computer devices 602, 604. For example, the computer devices 602, 604 may each include a networking module, such as rack switches 642, 620. The rack switches 642, 620 may each be a networking modules that transmits data from one computer device to another computer device (e.g., from computer device 604 to computer device 602, and vice versa).

An example operation of the MapReduce system 600 is now discussed with reference to FIG. 6. A job 612 is received by the job manager 614 on the master framework node 606. This is shown as label “A”.

Upon receiving the job 612, the job manager 614 may cause the distributed processing framework to process the job by distributing tasks corresponding to the job 612 to task managers operating at framework nodes within the framework node cluster that are at or near input data. As explained above, the tasks may be map or reduce tasks in a MapReduce framework. The tasks 648 and/or 624 may be tasks for the job 612.

In addition to distributing tasks to the framework node cluster, in some cases, the job manager 614, upon receiving the job 612, may instantiate the analysis engine 616. This is shown in FIG. 6 as label “B.” In an example, the job manager 614 may be configured to instantiate the analysis engine 616 based on a determination of whether the analysis engine 616 is already instantiated and operational. If the analysis engine 616 is already operational, the job manager 614 may alert the analysis engine 616 that the job 612 has been received.

The analysis engine 616 communicates a new job creation message to monitor daemons executing on framework nodes that are assigned to execute or monitor tasks for the job 612. In an example, the analysis engine 616 may broadcast the new job creation message to the monitor daemon 644 executing on the worker framework node 608 based on the worker framework node 608 being assigned to execute the tasks 648 from the job 612. Further, as an additional example, the analysis engine 616 may also broadcast the new job creation message to the monitor daemon 618 executing on the master framework node 606 based on the master framework node 606 being assigned to monitor the tasks 648 executing on the worker framework node 608 (that is, the tasks 624 (e.g., master tasks) may map to tasks operating on worker nodes, such as the tasks 648 (e.g., worker tasks) executing on the worker node 608, as the tasks 624 may coordinate execution of the tasks 648). Broadcasting the new job creation message to the monitor daemon 618 is indicated by label “C,” while the broadcast of the new job creation message to the monitor daemon 648 is indicated by labels “D” through to “G.”

Once the monitor daemons 618, 644 are notified that the job 612 has been submitted, the monitor daemons 618, 644 may track network bandwidth from the software defined network 635 which may be consumed by the framework node cluster as a result of processing the tasks 648, 624 of the job 612. Bandwidth of the software defined network 635 may be consumed by during a shuffle phase of in a MapReduce framework. The monitor daemon 618 collects resource usage data relating to the outgoing traffic and incoming traffic from the mappers and reducers (e.g. tasks 624). The monitor daemon 644 collects resource usage data relating to the outgoing traffic and incoming traffic from the mappers and reducers (e.g. tasks 648).

The monitor daemons 644, 618 may aggregate traffic at rack-level, which differs from fine-grained data (e.g., flow-level or packet level data), as may be tracked by NetFlow and IPFIX (Internet Protocol Flow Information Export) operating on a router or at the router level of a networking device. For example, the monitor daemon 644 may track resource usage data caused by activities initiated by the framework node 608 that consumes expensive compute resources with respect to a computational resource system. To illustrate, the monitor daemon 644 may differentiate between traffic exchanged by framework nodes in the same rack versus traffic exchanged by framework nodes in different racks. For traffic exchanged in the same rack, the monitor daemon 644 may ignore or elect to not track the resource consumption for that type of traffic. However, the monitor daemon 644 may track resource usage data caused by traffic between framework nodes on different racks. In this way, the monitor daemon 644 then tracks the bandwidth usage that crosses racks, as that type of resource usage may be thought as expensive in terms of system resource usage.

Still referring to FIG. 6, at a given frequency, the monitoring daemons 644, 618 may communicate the resource usage data to the analysis engine 616. Such monitored data may be communicated through a communication path that includes: a link (label “J”) connecting the worker framework node 608 to the rack switch 642; a link (label “K”) from the rack switch 642 to the software defined network 635, a link (label “L”) between the software defined network 635 to the rack switch 620, and, finally, a link (label “O”) between the rack switch 620 and the analysis engine 616.

In addition to receiving resource usage data from the monitor daemon 644 executing on the worker framework node 608, the analysis engine 616 receives resource usage data from the monitor daemon 618 executing on the master framework node 606, shown as label “N”. The analysis engine 616 stores the resource usage data in a database 650 and analyzes the resource usage data for the jobs executed by the framework. The analysis engine 616 may use the resource usage data to derive a prediction of an estimated amount of traffic for the job 612 (or jobs). This prediction can then be used by the analysis engine 616 to instruct the controller 630 through the path indicated by labels “D” and “E” with actionable data (e.g., an explicit request to reserve a given amount of resource or quality of service metric or a prediction of future resource needs). In some embodiments, to reduce the overhead introduced by communicating resource usage data between the monitor daemon 644 and the analysis engine 616, the analysis engines 616 may track the predictability of resource usage data for a job over time. If the resource usage data for the job is predictable, the analysis engine 616 may instruct the monitor daemon 644 to decrease the frequency in which the monitor daemon 644 communicates resource usage data to the analysis engine 616. If, on the other hand, the resource usage data for a job deviates from a prediction beyond a threshold amount, the analysis engine 616 may increase the frequency in which the monitor daemon 644 communicates the resource usage data.

As just discussed above with reference to FIG. 6, examples of the monitor daemon 644 may track resource usage data at a high level, such as at the job and rack-level, rather than at a low level, such as a flow or packet level. To illustrate, the monitor daemon 644 may collect the pieces of information of the bandwidth usage of the MapReduce framework by working with the name framework node 662 to create a data record with various MapReduce framework data. The record may include the following fields:

TABLE 1

| FIELD NAME | DESCRIPTION |
|---|---|
| Job Id | An identifier of a job |
| Source Rack | The rack where the traffic originates |
| Source Framework | The framework node within the rack the traffic |
| Node | originates |
| Destination Rack | The rack where the traffic goes to |
| Destination Framework | The framework node within the track the traffic |
| node | goes to |
| Volume of the Traffic | Total amount of traffic of this particular flow |
| Time Stamps | When the traffic starts and ends |
| Transmission Time | How long it takes for the traffic |
| and/or Turnaround Time | |

The analysis engine 616 can aggregate records received from the monitor daemon 644 and other monitor daemons executing in a distributed processing framework even further, based on a function of any of the above fields specified by Table 1. For example, the analysis engine 616 can aggregate records based on job counts, i.e. the number of jobs currently involved in the communications are created and inserted. The analysis engine 616 can go through another round of aggregation, where all data records of the same job are aggregated, for example, the volume of traffic or indications of cross rack traffic.

An mechanism in which the analysis engine 616 generates a prediction of the estimated amount of traffic for the job 612 is now discussed. Data for generating the prediction may include:

Traffic counts on job flows. Traffic counts on a job flow correspond to traffic flows caused by a particular job submitted to the distributed processing framework. Each job flow arises from the communication activities of a job. There are various ways that the job flow traffic measurements at a particular time, denoted as X(t), can be obtained. The job manager 614 records the sizes of individual partitions of the map output in matrix 1. The number of rows in I is the number of one type of task (e.g., mappers) and the number of columns is the number of another type of task (e.g., reducers). The element at row ‘a’ and column ‘b’ of matrix I tells the size of the flow from the task ‘a’ and task ‘b’. Summarizing all the elements of matrix I gives the data transfer used by the job at a given time.

Rack Traffic Counts. The rack traffic counts may record all the incoming and outgoing traffic amounts of a particular rack. There are various ways that the cross-rack traffic measurement at a particular time can be obtained. One mechanism for tracking cross-rack traffic is to install an S-flow component in a monitor daemon so that the monitor daemon can collect the data volume of cross-rack traffic.

Job Assignment Matrix. This matrix is an n by m matrix, where n is the number of racks and m is the number of job flows. Element at row i and column j is 1 if job flow i involves rack j. Apart from the analysis engine 616 using the job assignment matrix for bandwidth usage forecasting, the job assignment matrix can also be used by the computation resource system (e.g., a software defined network) for further analysis and bandwidth allocation adjustment.

Thus, an example of the analysis engine 616 may define a resource usage model usable to generate a prediction of future resource usage data, as a matrix y, and y is defined as:

y=Ax

In the above equation, y is a vector of rack traffic counts, x is a vector of traffic counts on job flows of size p, and A is a job assignment matrix, as described above.

The analysis engine 616 may perform a high-level bandwidth analysis based on a traffic prediction using the multivariate analysis technique of Principle Component Analysis (PCA) for feature analysis and Kalman filter (linear quadratic estimation (LQE)) for forecasting. The analysis can then be done according to the following:

Analysis Operation 1: Form job flow matrix XTX, where X is a t by p matrix formed by successive job flow traffic measurements over time t. This matrix is a measure of the covariance between the job flows.

Analysis Operation 2: Solve the symmetric eigenvalue problem for matrix X^{T}X: X^{T}Xvᵢ=λᵢvᵢ, i=1, . . . p. p represents the number of job flows. vᵢ is the ith eigenvector or ith principle component, and λᵢ is the eigenvalue corresponding to vᵢ. The k (k<<p) principle components are calculated in this operation.

Analysis Operation 3: Calculate the contribution of principle axis i as a function of time, i.e. Xvᵢ and normalize it to unit length, i.e. uᵢ=Xvᵢ/σᵢ, where σᵢ=(λᵢ)^{1/2}, and i=1, . . . p. uᵢ is of size t and orthogonal.

At this point, the above analysis operations identify a number of vectors that capture the time-varying trends of the job flows.

Analysis Operation 4: Form a p by p principle matrix V by arranging in order as columns the set of principle components {vᵢ}|i=1, . . . , p. Also form the t by p matrix U by arranging in order as columns the step of {uᵢ}|=1, . . . , p. The job flows can be written as Xᵢ=U(V^{T})ᵢ, i=1, . . . , p. Here Xᵢ is the time series of the ith job flow and (V^{T})ᵢ is the ith row of V.

Analysis Operation 5: Model Eigen vector evolution as a linear system: vₜ₊₁=Cvₜ+wₜ, where C is the state transition matrix, and wₜ is the noise process. The diagonal elements of C capture the temporal correlation during transition of the Eigen vectors and non-diagonal elements capture the dependency of one Eigen vector against another. wₜ is the fluctuations naturally occurring in job flows.

Analysis Operation 6: Approximate xₜ using the most significant r principle components (judged by the magnitude significance of the corresponding Eigen values, the number here being between 5-10) as:

X′=Σᵢ₌₁^{r}\hat{σ}ᵢ\hat{μ}ᵢ(\hat{ν}ᵢ)^{T}

These Eigen vectors show detectable patterns and periodicities and appear to be relatively predictable and the Eigen vectors capture the most significant energy of the traffic.

Analysis Operation 7: Prediction of t+1 value on information at time t based on the approximated xₜ in sub-steps:

[symbol]

_{t+1|t}=C [symbol] _{t|t}

P_{t+1|t}=CP_{t|t}C^{T}+Q

P in the above equations represents a covariance matrix for the errors at t. Q represents the covariance matrix of the state errors (e.g., wₜ).

[symbol]

_{t+1|t+1}= [symbol] _{t+1|k}+Gₖ₊₁[yₜ₊₁−A [symbol] _{t+1|t}]

P_{t+1|t+1}=(E−G_{t+1αt}A)P_{t+1|t}(E−G_{t+1|t}A)^{T}+Gₜ₊₁RGₜ₊₁^{T}

In the above equation, G is the Kalman gain matrix.

Analysis Operation 8: Prediction of t+1 value of ŷ_{t+1|t+1} at time t based on the approximated xₜ₊₁ using y=Ax.

The controller 630 may operate on the above prediction to make routing decisions based on a matrix of bandwidth availability Bₜ at time t. B_{i,j,t} is the available bandwidth on the link from the ith rack to the jth rack. B_{i,j,t} can be calculated as the difference between the link capacity and the predicted traffic usage (e.g., the actionable data) on the link. The following equation may be used by the controller 630 to calculate B_{i,j,t}.

B_{i,j,t}= [symbol] _{t+1|t+1}(i,j)

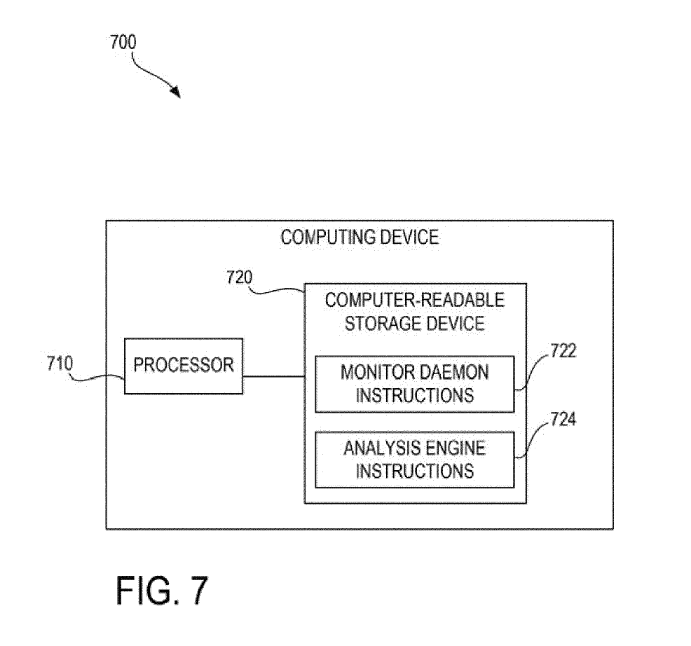

FIG. 7 is a block diagram of a computing device 700 capable of providing actionable data to a controller of a computational resource system based on monitored resource usage data, according to one example. The computing device 700 includes, for example, a processor 710, and a machine-readable storage medium 720 including instructions 722, 724. The computing device 700 may be, for example, a security appliance, a computer, a workstation, a server, a notebook computer, or any other suitable computing device capable of providing the functionality described herein.

The processor 710 may be, at least one central processing unit (CPU), at least one semiconductor-based microprocessor, at least one graphics processing unit (GPU), other hardware devices suitable for retrieval and execution of instructions stored in machine-readable storage medium 720, or combinations thereof. For example, the processor 710 may include multiple cores on a chip, include multiple cores across multiple chips, multiple cores across multiple devices (e.g., if the computing device 700 includes multiple framework node devices), or combinations thereof. The processor 710 may fetch, decode, and execute the instructions 722, 724 to implement methods and operations discussed above, with reference to FIGS. 1-6. As an alternative or in addition to retrieving and executing instructions, processor 710 may include at least one integrated circuit (IC), other control logic, other electronic circuits, or combinations thereof that include a number of electronic components for performing the functionality of instructions 722, 724.

Machine-readable storage medium 720 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 720 may be encoded with a series of executable instructions for updating a controller of a computational resource system based on resource usage data collected by a monitor daemon in a distributed processing framework.

As used herein, the term “computer system” may refer to a computer device or computer devices, such as the computer device 700 shown in FIG. 7. Further, the terms “couple,” “couples,” “communicatively couple,” or “communicatively coupled” is intended to mean either an indirect or direct connection. Thus, if a first device, module, or engine couples to a second device, module, or engine, that connection may be through a direct connection, or through an indirect connection via other devices, modules, or engines and connections. In the case of electrical connections, such coupling may be direct, indirect, through an optical connection, or through a wireless electrical connection. Still further, a software defined network is controlled by instructions stored in a computer-readable device.

What is claimed is:

1. A system comprising:
a framework node cluster of a distributed processing framework implemented by a computer system and communicatively coupled to a computational resource system that provides a computing capability to the framework node cluster, the framework node cluster to execute a plurality of tasks of a job submitted to the distributed processing framework,
wherein a first framework node from the framework node cluster includes:
a monitor daemon implemented by the computer system and to monitor resource usage data characterizing a compute resource consumed by the computational resource system in providing the computing capability to the framework node cluster, and
wherein a second framework node from the framework node cluster includes:
an analysis engine implemented by the computer system and to:
collect the resource usage data from the monitor daemon, and
update a controller of the computational resource system with actionable data usable by the controller to schedule compute resources for providing the computing capability at a future time, the actionable data being derived from the resource usage data.

2. The system of claim 1, wherein a third framework node from the framework node cluster includes:
an additional monitor daemon implemented by the computer system and to monitor additional resource usage data characterizing an additional compute resource consumed by the computational resource system in providing the computing capability to the framework node cluster, where the compute resource consumed and the additional compute resource consumed relate to different framework nodes of the framework node cluster and
wherein the analysis engine further to collect the additional resource usage data from the additional monitor daemon, wherein the actionable data being further derived from the additional resource usage data.

3. The system of claim 1, wherein the analysis engine is to use the resource usage data by generating a resource usage model that estimates future resource usage of the compute resource of the computational resource system in providing the computing capability at the future time.

4. The system of claim 1, wherein the analysis engine is to communicate an estimate of resource usage for a future time through an interface of the controller of the computational resource system, the estimate of resource usage being derived from the collected resource usage data.

5. The system of claim 1, wherein the resource usage data includes data corresponding to at least one of: a measurement of memory, a measurement of a communication bandwidth, a measurement of processor time utilized, a number of requests sent to a message queue, or a number of virtual machines.

6. The system of claim 1, wherein the analysis engine further to generate a prediction error from the collected resource usage data, wherein the updating of the controller is performed based on a comparison between the prediction error and a prediction quality threshold.

7. The system of claim 1, wherein the plurality of tasks include a mapper task and a reducer task, the mapper task being executed by a first framework node in the framework node cluster and the reducer task being executed by a second framework node in the framework node cluster, wherein the monitor daemon further to monitor the resource usage data by tracking an amount of data being transmitted by the first framework node of the framework node cluster during a shuffling process that exchanges data, through the computational resource system, from the mapper task executing on the first framework node to the reducer task executing on the second framework node.

8. The system of claim 1, further comprising aggregating the resource usage data based on at least one of: a job identifier, a rack, a framework node, a volume of traffic, a time stamp, or a transmission time.

9. The system of claim 1, wherein the update to the controller causes the controller to modify the data plane of a network that communicates framework messages among framework nodes of the framework node cluster.

10. A method of updating a controller of a computational resource system that provides a computing capability to a distributed processing framework:
collecting, by an analysis engine of the distributed processing framework, resource usage data characterizing consumption of a compute resource of the computational resource system in providing the computing capability to framework nodes of the distributed processing framework; and
using the resource usage data, updating, by the analysis engine, the controller of the computational resource system with actionable data affecting the computing capability.

11. The method of claim 10, wherein using the resource usage data comprises generating a resource usage prediction that estimates a future resource usage of the computational resource system in providing the computing capability to the distributed processing framework.

12. The method of claim 10, further comprising updating a frequency in which a monitor daemon of the distributed processing framework collects the resource usage data.

13. The method of claim 10, wherein the resource usage data includes at least one of:
a traffic count that measures traffic communicated between a plurality of tasks executed by the distributed processing framework over various time periods;
a rack traffic count that measures traffic between racks hosting framework nodes of the plurality of framework; or
a job assignment matrix that identifies racks that execute at least one task from the plurality of tasks.

14. The method of claim 10, wherein a plurality of tasks executing on a plurality of framework nodes of the distributed processing framework are phase-based tasks that process one or more jobs submitted by a user of the distributed processing framework, the compute resource is used to move the distributed processing framework from a first phase to a second phase.

15. A computer-readable storage device comprising instructions that, when executed, cause a processor of a computer device to:
collect resource usage data from a monitor daemon executing on a framework node of a plurality of framework nodes of a distributed processing framework, the resource usage data characterizing consumption of a compute resource of a computational resource system that provides a computing capability to the framework node; and
update, based on the resource usage data, a controller of the computational resource system with actionable data usable to affect the computing capability.
